(19) United States
(12) Patent Application Publication
(10) Pub. No.: US 2005/0034887 A1
(43) Pub. Date: Feb. 17, 2005

(54) Device and method for forming support systems for electric generator components

(75) Inventors: William F. Jones, Oviedo, FL (US); Mark L. Miller, Orlando, FL (US)

Correspondence Address: Siemens Corporation;Intellectual Property Department, 170 Wood Avenue South, Iselin, NJ, 08830, US

(73) Assignee: Siemens Westinghouse Power Corporation

(21) Appl. No.: 10/644,562

(22) Filed: Aug. 15, 2003

(51) Int. Cl. H02G 3/08

(52) U.S. Cl. 174/52.1

(57) ABSTRACT

A device for producing a workable material usable to form supports for supporting components, which may be stator coils, in a generator. In at least one embodiment, the supports may be braces positioned between adjacent stator coils. The device may include a housing having a heater for heating a workable material. The workable material may be received through a tube coupled to the housing. The workable material may be heated to a minimum temperature and ejected from the device using an ejector. The ejector may be controlled using a trigger coupled to the housing or to a handle coupled to the housing. The device may eject a workable material into a void between adjacent generator components, such as stator coils, to provide a formed in place support structure for limiting movement of the coils during operation of the generator.

### FIELD OF THE INVENTION

This invention is directed generally to generators, and more particularly to devices for creating support structures for electric generator components.

### BACKGROUND

An electrical generator is generally composed of a plurality of stator coils having support from banding and bracing. For proper operation of an electric generator, the stator windings must be supported to prevent movement of the windings during normal operating conditions and various fault conditions. Typically, a variety of configurations of rigid materials, compressible felts, and expandable hoses are used to provide support, or bracing, to the stator windings in a generator. While these devices each provide sufficient support for the stator windings, these devices must be custom fitted into voids between adjacent stator coils to form braces. Customizing these devices requires considerable amounts of hand work and consumes large amounts of time. In addition, a great deal of time is required to install these devices. For instance, a modern air-cooled 220 megavolt ampere (MVA) generator consists of about 108 stator coils. Braces must be placed between each of the coils, which may take between about three minutes and about thirty minutes for each coil. Thus, installing braces in a 220 MVA generator may take between about 100 hours and about 150 hours.

Once these have been installed to form braces, the braces undergo a post bake process to completely cure the resins forming these devices. The post bake process is time consuming as well. For instance, a typical post bake process may take between about 24 hours and about 48 hours. Thus, a need exists for a device and method for supporting components in electric generators that is less time consuming than conventional devices and methods.

### SUMMARY OF THE INVENTION

This invention relates to a device for producing a workable material used to create one or more supports for components in a generator, which may be, but are not limited to, stator coils and other components. In at least one embodiment, the workable material may be used to form braces and blocks used to support stator windings during installation of the winding and during operation of the generator. In at least one embodiment, the workable material may be, but is not limited to, a bulk molding compound, a b-stage material, one or more resins, and other like materials.

The device may be formed from a housing. The housing may have any one of a variety of outside surface configurations, and in at least one embodiment, may be a hand held device. One or more heaters may be coupled to the housing at an orifice in the housing for heating the workable material contained in the housing. The heater may be actuated using one or more switches coupled to the housing. Use of the heater may eliminate the need for using a post bake process. A tube may be coupled to the housing for containing the workable material and directing the workable material into proximity of the at least one heater coupled to the housing. In at least one embodiment, the tube may be releaseably coupled to the housing. The device may also include one or more ejector devices for expelling the workable material from the housing. The ejector device may be actuated using a trigger. The trigger may be coupled to the housing, to a handle coupled to the housing, or to another accessible location. In at least one embodiment, the ejector may eject the workable material from a channel coupled to the housing. In at least one embodiment of the device, a mixing chamber may be coupled to the housing for mixing the workable material with a catalyst, if necessary.

The device may be used to form a support structure between adjacent components in a generator. The device may be used by first inserting a workable material into the tube. The device may be adapted to emit a workable material in a substantially non-cured state between adjacent components of a generator. The workable material may be guided into the housing where the workable material may be subjected to at least a minimum threshold temperature to create a heated workable material. Once the workable material has been heated to the minimum temperature, the workable material may be passed from the housing into a void between adjacent components in a generator by ejecting the workable material in a non-cured state from the device. The workable material may be formed in the void between adjacent components of the generator so that the workable material contacts at least a portion of adjacent components defining a void and desired to be secured in place in the generator and cures to a solid material capable of supporting the adjacent components of the generator.

An advantage of this invention is that the device may be used to form bracing and blocking between stator coils and other components by simply injecting the pliable, workable material into a void, rather than, custom fitting hard, previously cured materials into the voids. Use of the pliable material results in a time savings of about 70 percent over use of previously cured, custom-fitted blocks and braces.

Another advantage of this invention is that formation of a brace or block using this device eliminates the need for a conventional post bake process, which results in additional time savings. The time savings realized by these advantages alone can greatly shorten the amount of time needed to manufacture a generator as formation of stator coils and required bracing and blocking using conventional technology takes between about 100 hours and 150 hours and creation of stator coil and required bracing and blocking using this device may take only between about 30 hours and about 50 hours.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a device having features according to this invention.

FIG. 2 is a cross-sectional view of another embodiment of a device according to this invention.

FIG. 3 is top schematic view of an alternative embodiment of a device according to this invention.

FIG. 4 is a side schematic view of the alternative embodiment shown in FIG. 3.

### DETAILED DESCRIPTION OF THE INVENTION

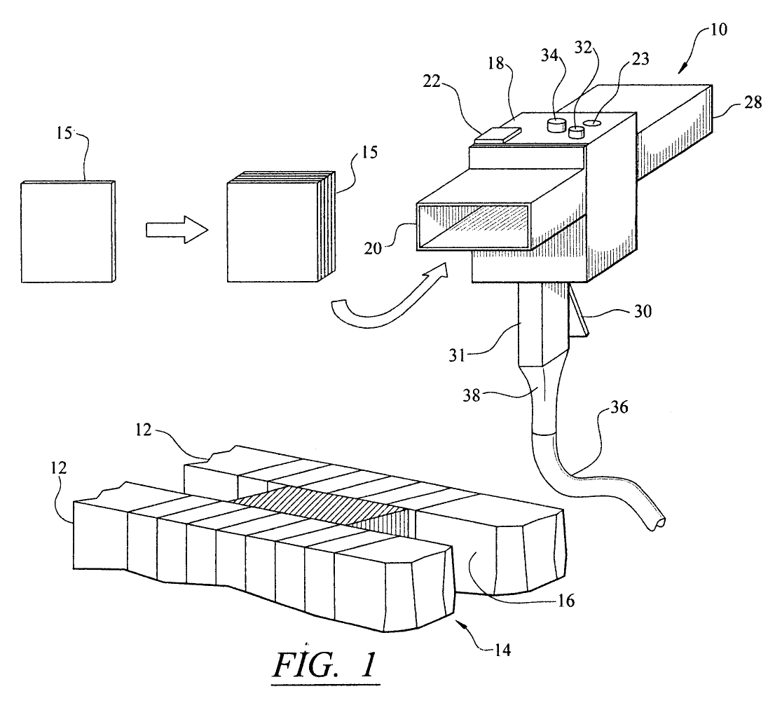

As shown in FIGS. 1-4, this invention is directed to a device 10 for producing a workable material to support one or more components 12 in a generator 14, which may be, but are not limited to, stator coils and other components. The workable material may be used to form braces and blocks used to support stator windings during installation of the winding. The device 10 may produce a workable material that may be applied to fill a void 16 between generator components 12 after the components 12 have been installed in the generator 14. The workable material 15 may solidify to keep the components 12 of the generator 14 in place and to limit the amount of movement that the components 12 may undergo while the generator 12 is operating.

In at least one embodiment, the workable material may be, but is not limited to, a bulk molding compound, a b-stage material, one or more resins, a sheet molding compound, such as, but not limited to, QUANTUM LYTEX 9063 or QUANTUM LYTEX 4129 having random glass fibers and being produced by Quantum Composites, Inc., Bay City, Mich., any combinations thereof, and other like materials. In at least one embodiment, the workable material may be an epoxy-glass formulation having between about 30 percent and about 65 percent glass, or a vinyl ester, such as, but not limited to, QC 8880, as produced by Quantum Composites, Inc. The workable material is not limited to conventional materials. Rather, the workable material may be any customized material that may be a mixture of multiple materials or a single material adapted for use in a specific location. For instance, layers of catalyst may be placed in a mold charge usable as a workable material. Each application of the workable material using the device 10 is often a custom process.

The device 10 may be formed from one or more housings 18. The housing 18 may have an outside surface having any one of a variety of configurations. In at least one embodiment, the device 10 may be a handheld device. One or more hollow tubes 20 may be coupled to the housing 18 for receiving a workable material 15. The inner aspects of the hollow tube 20 may be aligned with an orifice in the housing to permit a workable material to be passed through the tube 20 and into the housing 18. The tube 20 may have a cross-section shaped as a cylinder, square, rectangle, or other appropriate shape. The tube 20 may also be formed from metal and other materials capable of withstanding heat generated by the device 10. In at least one embodiment, the tube 20 may be removably attached to the housing 18. The tube 20 may be attached to the housing 18 using threads or other releasable connection device.

The device 10 may include one or more heaters 22 for applying heat to a workable material 15. In at least one embodiment, one or more heaters 22 may be capable of applying heat to a workable material 15 while the workable material 15 is positioned in the housing 18. The heater 22 may be positioned inside the housing 18 in at least one embodiment. The heater 22 may be positioned so that the heater 22 is capable of emitting heat that causes the temperature of a workable material 15 contained in the housing 18 to rise. The heater 22 may be any heater capable of being sized sufficiently to fit in the housing 18. In other embodiments, the heater 22 may be positioned outside of the housing 18 and may direct heat into the housing 18. A temperature measuring device 23, which may be, but is not limited to, a thermometer, a thermocouple, or a resistance temperature detector (RTV), may be positioned in the housing 18 for determining the temperature of the air in the housing 18.

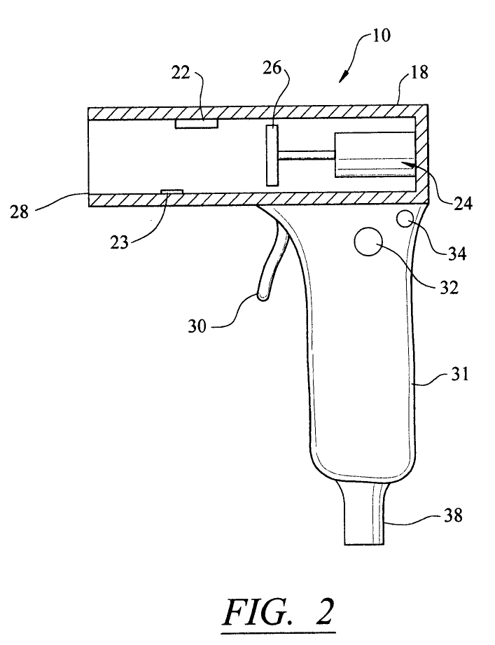

The device 10 may include at least one ejector 24, as shown in FIG. 2, for ejecting a workable material from the housing 18. The ejector 24 may be formed from one or more ram pistons 26 movable relative to the housing 18. In at least one embodiment, the ram piston 26 may be air driven. Alternatively, in at least another embodiment, the ram piston 26 may be electrically driven or hydraulically driven. A channel 28 may be coupled to the housing 18 for guiding the workable material 15 from the housing 18 after the ram piston 26 has ejected the workable material 15 from the housing 18. The channel 28 may have a nozzle or other device for more accurately directing the workable material 15 as the material is emitted from the channel 28. The channel 28 may be formed from a tube having one or more shaped cross-sections. The channel 28 may also be formed from two sides forming a V-shape or from a bottom surface coupled to two or more side walls.

The device 10 may also include a trigger 30 for actuating the ejector 24. The trigger 30 may have an outer surface ergonomically configured to be easily actuated. The trigger 30 may operate such that squeezing the trigger 30 turns the ejector 24 on. In one embodiment, the trigger 30 may require that the trigger 30 remain depressed for the ejector 24 to remain in an on state. In other embodiments, depressing and releasing the trigger 30 actuates the ejector 24. The ejector 24 may be deactivated by depressing and releasing the trigger 30. The trigger 30 may be coupled to the housing 18. In other embodiments, the trigger 30 may be coupled to a handle 31. The handle 31 may have an outside surface that may be ergonomically configured to fit in the palm of a user's hand.

The device 10 may also include one or more switches 32 for activating the heater 22. The switch 32 may be coupled to the housing 18 or other components forming the device for producing a workable material 10. The switch 32 may be a toggle switch, a depressable type switch, or other type switch. The switch 32 may be in electrical communication with one or more indicators 34 for indicating the state of the heater 22. In one embodiment, the indicator 34 and the switch 32 may be a single unit. The indicator 34 may be configured to be in an on state while the heater 22 is running. The indicator 34 may emit an audio or visual indication, or may emit both indications, indicating that the heater 22 is running or that the heater 22 is off. The audio indication may be a single beep, a series of beeps, or other sound. The visual indication may be a light, such as, but not limited to a light emitting device (LED), that remains lit continuously while the heater 22 is on, or that blinks once or in a series of blinks, indicating the heater 22 is on or off.

In at least one embodiment in which the ejector 24 is electrically driven, a power cord 36 may be coupled to the device 10. The power cord 36 may be coupled to a fitting 38 on the device 10. The fitting 38 may be a conventionally sized male or female power plug. Thus, the power cord 36 may be removably attached to the device 10. In embodiments in which the ejector 24 is air driven, a fitting 38 may be coupled to the device 10 to enable an air supply hose to be releasably coupled to the device 10.

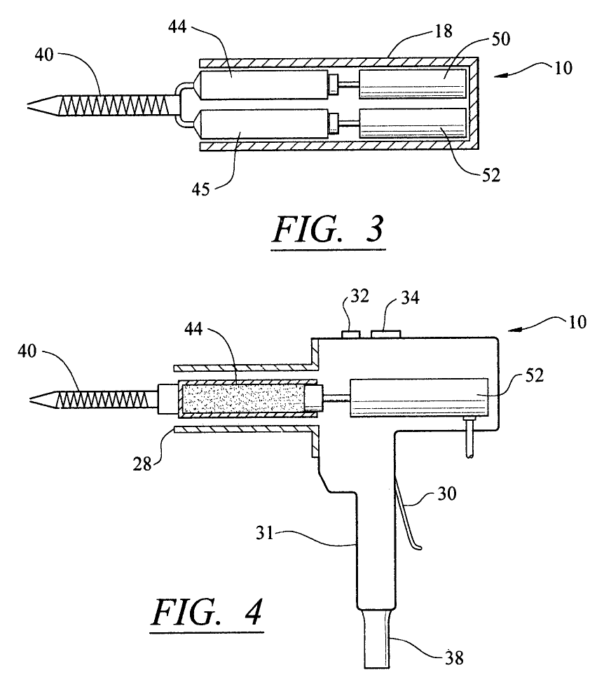

As shown in FIGS. 3 and 4, the device for producing a workable material 10 may also include a mixing chamber 40 for mixing two or more materials together. The materials may be contained in two or more containers 44 and 45. The containers 44 and 45 may be any configuration appropriate to contain and emit a workable material. The device for producing a workable material 10 may include two or more ejectors 50 and 52 for ejecting workable materials from the containers 44 and 45 into the mixing chamber 40. In at least one embodiment, the mixing chamber 40 may be, but is not limited to, a cylinder, which may be referred to as a static mixer. The mixing chamber 40 may be sized to be inserted into a bladder or other container, such as felt, positionable between stator coils 12.

In at least one embodiment, the device 10 may be included as a part of a system including a first generator component 12 and a second generator component 12 positioned adjacent to each other and having the void 16 positioned between the first and second generator components 12. The device 10 may be formed from any one of the embodiments described above.

During operation, a workable material 15 may be inserted into the tube 20. The workable material 15 may be made more workable by applying heat to the material. Adding heat to the workable material may eliminate the need for a conventional post bake process typically applied to the generator 14. As workable material 15 is inserted into the tube 20, the material 15 is exposed to heat emitted from the heater 22. In at least some embodiments, the heat may cause the workable material 15 to become as pliable as conventional putty. In some embodiments, the workable material 15 may be inserted into mixing chamber 40 so that the workable material 15 may be mixed with a catalyst, which may or may not be contained in container 44.

Once the workable material 15 has reached a predetermined temperature, as may be determined using the temperature measuring device 23, the workable material 15 may be ejected from the housing 18 using the ejector 24. In at least one embodiment, the workable material 15 may be ejected in a non-cured state. The ejector 24 may be actuated by moving the trigger 30. The ejector 24 may eject at least a portion of the moldable 15 material contained in the housing 18 through the channel 28. In at least one embodiment, the workable material 15 may be ejected through a nozzle coupled to the channel 28. The workable material 15 may be ejected from the device 10 into a void 16 found between adjacent components 12 in a generator 14. In at least one embodiment, the void 16 may be located between adjacent stator coils 12. The workable material 15 may be formed in the void 16 so that the workable material 15 contacts at least a portion of the adjacent generator components 12 defining the void 16 and desired to be secured by the workable material 15. The workable material 15 may be formed so that it does not interfere with other components in the generator 14 not desired to be contacted by the workable material 15.

The foregoing is provided for purposes of illustrating, explaining, and describing embodiments of this invention. Modifications and adaptations to these embodiments will be apparent to those skilled in the art and may be made without departing from the scope or spirit of this invention.

1. A method of securing components of a generator, comprising:
inserting a workable material into a device for producing a workable material usable in generators, wherein the device is adapted to emit a workable material in a substantially non-cured state between adjacent components of a generator;
ejecting the workable material in a non-cured state from the device into a void between adjacent components of the generator; and
forming the workable material in the void between adjacent components of the generator so that the workable material contacts at least a portion of adjacent components defining the void and desired to be secured and cures to a solid material capable of supporting the adjacent components of the generator.

2. The method of claim 1, wherein inserting a workable material into a device for producing a workable material usable in generators comprises inserting a workable material into a device including a housing; at least one heater coupled to the housing for heating the workable material; at least one hollow tube coupled to the housing at an orifice in the housing for containing the material and directing the material into proximity of the at least one heater coupled to the housing, the at least one tube configured to emit the workable material in a non-cured state between the support components in the generator; at least one ejector device coupled to the housing for ejecting the workable material from the housing; and at least one trigger for actuating the at least one ejector to heat the workable material.

3. The method of claim 1, wherein inserting a workable material into a device for producing a workable material usable in generators comprises inserting a b-stage material into the device for producing a workable material usable in generators.

4. The method of claim 1, wherein inserting a workable material into a device for producing a workable material usable in generators comprises inserting a bulk molding compound into the device for producing a workable material usable in generators.

5. The method of claim 1, wherein inserting a workable material into a device for producing a workable material usable in generators comprises inserting a custom made workable material.

6. The method of claim 1, wherein inserting a workable material into a device for producing a workable material usable in generators further comprises inserting the workable material into a mixing chamber coupled to the housing for mixing the workable material with a catalyst.

7. The method of claim 1, wherein ejecting the workable material in a non-cured state from the device into a void between adjacent components of the generator comprises ejecting the workable material into a bladder positioned between adjacent components of a generator.

8. The method of claim 1, further comprising heating the workable material to at least a minimum threshold temperature to create a heated workable material.

9. A device for producing a workable material usable to support components in a generator, comprising:
a housing adapted to receive at least one workable material having properties enabling the workable material to be used to support components in the generator;
at least one heater coupled to the housing for heating the workable material;
at least one removable hollow tube coupled to the housing at an orifice in the housing for containing the material and directing the material into proximity of the at least one heater coupled to the housing, the at least one tube configured to emit the workable material in a non-cured state between the support components in the generator;
at least one ejector device coupled to the housing for ejecting the workable material from the housing;
at least one channel for guiding the workable material from the housing;
a switch for actuating the at least one heater;
at least one indicator for indicating that the heater has reached a threshold preheat temperature; and
at least one trigger for actuating the at least one ejector to heat the workable material.

10. The device of claim 9, wherein the ejector device comprises at least one ram piston movable relative to the housing to eject the workable material from the housing.

11. The device of claim 9, wherein the at least one ram piston comprises at least one air driven piston.

12. The device of claim 9, wherein the at least one ram piston comprises at least one electrically driven piston.

13. The device of claim 9, wherein the at least one indicator for indicating that the heater has reached a threshold preheat temperature comprises at least one LED.

14. The device of claim 9, further comprising a fitting coupled to the housing and adapted to be coupled to a standard power plug.

15. The device of claim 9, further comprising at least one mixing chamber coupled to the housing for mixing a workable material with at least one catalyst.

16. The device of claim 9, further comprising at least one temperature measuring device coupled to the housing.

17. The device of claim 9, wherein the workable material is selected from the group consisting of a bulk molding compound, a sheet molding compound, and a custom made material.

18. A system for supporting components in a generator, comprising:
a device for emitting a workable material between adjacent components of a generator to secure the components, the device comprising:
a housing adapted to receive at least one workable material having properties enabling the workable material to be used to support components in the generator;
at least one heater coupled to the housing for heating the workable material;
at least one hollow tube coupled to the housing at an orifice in the housing for containing the material and directing the material into proximity of the at least one heater coupled to the housing, the at least one tube configured to emit the workable material in a non-cured state between the support components in the generator;
at least one ejector device coupled to the housing for ejecting the workable material from the housing; and
at least one trigger for actuating the at least one ejector to heat the workable material;
a first generator component coupled to a generator; and
a second generator component coupled to the generator adjacent to the first generator component, wherein the first and second generator components are separated by a void.

19. The device of claim 18, further comprising at least one mixing chamber coupled to the housing for mixing a workable material with at least one catalyst.

20. The device of claim 18, wherein the workable material is selected from the group consisting of a bulk molding compound, a sheet molding compound, and a custom made material.
